(19) United States
(12) Patent Application Publication
(10) Pub. No.: US 2020/0353478 A1
(43) Pub. Date: Nov. 12, 2020

(54) SYSTEM AND METHOD FOR SEPARATION OF CHIRAL COMPOUNDS USING MAGNETIC INTERACTIONS

(71) Applicants: YEDA RESEARCH AND DEVELOPMENT CO. LTD., Rehovot (IL); YISS RESEARCH DEVELOPMENT COMPANY OF THE HEBREW UNIVERSITY OF JERUSAL LT, Jerusalem (IL)

(72) Inventors: Ron NAAMAN, Yarkona (IL); Eyal CAPUA, Rehovot (IL); Meir LAHAV, Rehovot (IL); Francesco TASSINARI, Rehovot (IL); Yossef PALTIEL, Maskeret Batya (IL); Shira YOCHELIS, Ness Ziona (IL)

(21) Appl. No.: 16/642,217

(22) PCT Filed: Aug. 26, 2018
(86) PCT No.: PCT/IL2018/050942

§ 371 Date: Feb. 26, 2020

Related U.S. Application Data
(60) Provisional application No. 62/620,503, filed on Jan. 23, 2018.
(60) Provisional application No. 62/636,903, filed on Mar. 1, 2018.

(30) Foreign Application Priority Data
Aug. 29, 2017 (IL) 254209

(51) Int. Cl. B03C 1/30; B03C 1/023; B03C 1/033; B03C 1/28

(52) U.S. Cl. CPC B03C 1/30; B03C 1/023; B03C 2201/18; B03C 1/288; B03C 2201/22; B03C 1/0332

(57) ABSTRACT

Systems and methods are disclosed for use in the separation of chiral compounds, and enantiomers in particular. The system comprises a cavity (110) for containing a fluid mixture that comprises one or more types of chiral molecules, which may also include enantiomers, and at least one ferromagnetic or paramagnetic substrate (120) providing at least one interface (130) with said fluid mixture. The substrate (120) is magnetized providing a magnetic field Bz perpendicular to said ferromagnetic or paramagnetic interface (130), thereby providing a variation in the interaction energy of chiral molecules of different handedness, aka. enantiomers, with said substrate (120).

### TECHNOLOGICAL FIELD

This present invention is in the field of separation and selection of desired compounds and specifically directed to separation of chiral molecules compounds using magnetic interactions. The technique of the invention may be suitable for separation of molecules using crystal, liquid or gas phase.

### BACKGROUND

Biological systems are based on molecules of a specific chirality, separating the two enantiomers of chiral molecules is a central process in the pharmaceutical and chemical industries. Separation of chiral molecules/compounds may also be relevant to the food, food additives, perfume and agrichemical market. Today, the chromatographic separation process is mainly based on the different interaction between the two enantiomers and the molecules having specific chirality that are adsorbed on surfaces of the chromatograph. The differences between the two enantiomers are usually small and the lock and key interaction needed to separate is week. The analytical chromatography technique separates mixtures of molecules by differential partitioning occurring between two phases: the mobile phase, in which the molecules are carried upon, and the stationary phase, fixed to a structure (usually beads within a column), in which the molecules in the mixture interact with. When the mixture is loaded or injected and passes through the structure the molecules in the mixture propagate at different speeds, and hence, separate. Additionally, the separation may typically requires selecting specific molecules to be adsorbed on the stationary phase of the chromatograph for separation a single or restricted group of several specific molecules, to their enantiomers. Therefore, the separation might be difficult and expensive. Separate and specific columns have been developed for small selection of molecules. There are chiral molecules in which the chiral center is imbedded within the molecular structure and therefore these molecules cannot be separated to their enantiomers following the common concept. In addition, separation of mixture of chiral molecules and of proteins according to their secondary structure is desired for diagnostic and for pharmaceutical applications.

Another popular method has been developed to enantio-separate racemic mixture of chiral compounds, which is based on their enantio-specific crystallization. Generally, there are three kinds of racemate as far as crystallization is concerned: conglomerates, racemic compounds, and solid solutions. In the first, two enantiomers can interact with a proper reagent to form new complex compounds of diastereomers. Since the two resulting diastereomers have different physicochemical properties, they can be selectively crystallized through traditional techniques. This separation of enantiomers via the formation of corresponding diastereomeric salts is called diastereomeric crystallization. The relative simplicity and low cost of diastereomeric crystallization makes it one of the preferred methods for separating racemic compounds into enantiomers for industrial clinical use. Typically, in the crystallization method the racemic mixture is seeded with crystals of one enantiomer, causing its crystallization. The actual separation between the diastereomers is a major challenge. Achieving high purity with this method is difficult and the optimization of the parameters is a complex process. The diastereomeric crystallization method is therefore applicable to a relatively small fraction of molecules.

It was recently found that when chiral molecules are electrically polarized by electric field, the electric polarization is accompanied by spin polarization. Resulting from a state where at each electric pole there is an unpaired electron, or part of an electron, which spin orientation depends on the specific chirality of the molecule. In addition, it was found that when chiral molecules are adsorbed on a ferromagnetic substrate which is initially not magnetized, the substrate tends to magnetize, and the direction of the magnetic dipole depends on the specific chirality. Namely, one enantiomer will cause the substrate to be magnetized with the magnetic dipole pointing up, the other enantiomer will cause the dipole to point down.

### GENERAL DESCRIPTION

There is a need in the art for a technique enabling separation of chiral molecules. Such separation may for example be used in various chemical and biological processes including production of pharmaceutical compounds where proper selection of enantiomers of chiral molecules is highly important. The present invention provides a system and methods for separation of chiral compounds by interaction with magnetic substrates, allowing separation of enantiomers of common chiral molecular structure being mirror reflections as well separation of chiral molecules is general. The technique utilizes spin exchange and the spin polarization that accompanied charge polarization within chiral molecules, resulting in variation in interaction energy with magnetic interface for separation of the chiral molecules from a fluid mixture, i.e. liquid or gas. It should be noted that for simplicity, the term fluid is used herein as relating to describe liquid or gas, including low gas flow, where separate molecules may behave as particles in vacuum. Accordingly, the term fluid as used herein relates to liquid, gas and/or beam of molecules in gas phase, the terms liquid or gas when used separately relate to the corresponding phase of matter. In this connection the term interaction energy as used herein relates to binding energy between the molecules and the surface, or more specifically to the energy required for desorbing the molecules after interacting with the surface

Generally, variation in interaction energy between the different chiral molecules (e.g. different enantiomers) and a magnetic substrate (e.g. ferromagnetic or paramagnetic substrate being magnetized) results in variation in various interaction properties. This may be associated with interaction rate, time of interaction and probability of interaction. The interaction with the substrate is associated with changes in spin distribution in the chiral molecules due to charge redistribution upon approaching the magnetic substrate. Specifically, the enantiomers having handedness that results in spin redistribution, such that at the interacting regions between the molecules and the ferromagnetic substrate electrons have spin that is polarized parallel with the spin in the magnetic substrate have lower interaction energy and therefore will have shorter interaction time with the substrate. This is while opposite handedness results in anti-parallel spins alignment that increases the interaction energy resulting in longer interaction time with higher probability.

More specifically, the present technique is based on the inventor's understanding that charge reorganization in a chiral molecule is accompanies by spin polarization. Accordingly, charge polarization, generally occurring in molecular interaction or when in close proximity to a surface, in combination with spin selectivity in transmission through chiral molecular structure, results in redistributed electrons (or electronic density) having preferred spin direction associated with each electric pole. The correlation between the spin direction and the electric pole depends on the specific handedness of the molecule, namely it will be different for each enantiomer. The spin polarization effect in the isolated molecule is generally short lived, and spin may redistribute within a short time. However, when the spin on the molecule interacts with the spin of the ferromagnet, the spin may be fixed for longer times, e.g. the spin may not change in time as long as the interaction persists. The spin dependent interaction is short range and rely on the proximity of the molecules to the interacting substrate.

The difference in spin polarization of molecules having opposite chirality, enables separation using parameters such as the interaction time of the molecule with spins in the magnetic surface Having magnetization directed perpendicular to the surface (either pointing up or down). While one enantiomer will have weak interaction with the surface and therefore short interaction time, the other will have stronger interaction and therefore longer interaction time. More specifically, the chiral molecules are allowed to interact with a surface having selected magnetization (e.g. by adsorption on the surface), while flowing along the surface to avoid long adsorption times. The differences in interaction time of the different enantiomers affect the corresponding flow characteristics allowing collection of selected enantiomer over the other. Alternatively, the present technique utilizes spin polarization of chiral molecules to promote crystallization of selected enantiomers from racemic mixture.

To this end, the present technique utilizes a cavity (being in the form of chamber, channel, column or other) adapted to accept fluid (liquid or gas) mixture comprising one or more types of chiral molecules. The cavity comprises at least one substrate or surface having ferromagnetic or paramagnetic interface with the fluid mixture. The at least one surface is configured to be magnetized for operation in separation of the chiral molecules. Magnetization of the at least one surface is generally in a direction perpendicular to the interface provided by the surface, when the magnetic field is oriented either away or towards the interface, referred herein as up or down magnetization directions.

In some configurations, the fluid mixture comprising one or more types of chiral molecules is a liquid mixture. The cavity is configured as a column allowing flow of the liquid mixture at a selected rate through the column, while maintaining certain contact at one or more regions of interface between the solution and at least one surface/substrate, being magnetized perpendicular to the interface in one of up or down magnetization direction. While flowing within the column, molecules of the fluid mixture occasional adsorb onto the surface and may typically be released from the surface after short time and proceed with the flow. The variation in interaction energy between molecules of different handedness result in corresponding variation in time characteristics of interaction with the surface. This may provide variation in adsorption rate of different enantiomers, or molecules of different chirality, as well as cause molecules of one handedness to adsorb for relatively long time with respect to molecules of the opposite handedness. As a result, the molecules with higher interaction energy (longer interaction time) propagate slower within the column as compared to molecules having lower interaction energy (or shorter interaction time). Therefore, the technique enables separation of chiral molecules based on flow rate through the channel.

In some other configurations, the fluid mixture is in the form of gas. The cavity/chamber is configured as a vacuum chamber having inlet port, outlet port and at least one surface configured to be magnetized as described above. The at least one surface is magnetized and positioned within the cavity at a selected location and orientation such that particles arriving through the inlet port, impinging onto the surface, and being reflected therefrom, are directed toward the outlet port. In case of two or more surfaces, the surfaces are arranged to provide cascaded reflections and scattering of the enantiomer gas particles from the inlet port toward the outlet port. As the one or more surfaces are magnetized, chiral molecules of one enantiomer experience stronger interaction and therefore higher probability for random scattering over chiral molecules of the opposite enantiomer. More specifically, the molecules that adsorb for longer time onto the surface, are generally released therefrom at random directions, reducing the probability that these molecules will complete the path to the outlet port. This is while molecules of the opposite handedness (opposite enantiomers) have lower interaction energy and accordingly relatively shorter interaction time (or lower probability to adsorb) on the surface and are typically reflected from the surfaces at a specular angle and directed toward the outlet port to be collected.

According to yet some additional configurations, the fluid mixture is a liquid mixture comprising one or more types of molecules. The at least one surface providing magnetized interface with the fluid mixture is configured for operating as nucleation center for crystallization of the molecules. This technique enables crystallization of chiral molecules of one specific selected enantiomer, as well as crystallization of chiral supermolecular structures formed from achiral molecules.

According to some embodiments, the present invention provides a system for separating chiral molecules/compounds present in a fluid sample, the system comprises:
a flow pass configured for directing flow of a fluid sample, wherein the fluid sample flows through it;
at least one fluid inlet and at least one fluid outlet; and
the flow pass is configured with at least a portion comprising a ferromagnetic or paramagnetic material.

Said at least a portion comprising a ferromagnetic or paramagnetic material, may provide interface between said fluid sample and a surface of said ferromagnetic or paramagnetic material. The ferromagnetic or paramagnetic material may be magnetized at a direction perpendicular to said surface in direction up or down with respect to the interface.

In some embodiments, the system further comprises: a first substrate comprising said flow pass therein; and a second substrate covering the flow pass; such that at least a portion of a surface of the first substrate, or of the second substrate or of combination thereof is ferromagnetic or paramagnetic and the ferromagnetic or paramagnetic surface portion defines a boundary of the flow pass.

According to some embodiments, the invention provides a method for separating chiral compounds present in a fluid sample, the method comprises:
introducing a fluid sample comprising chiral compounds to a flow pass having at least one inlet and at least one outlet, the flow pass is configured with at least a portion comprising a ferromagnetic or paramagnetic material; and
collecting, at predefined times the eluted compounds from said outlet.

In some embodiments, the invention provides a method for separating chiral compounds present in a fluid sample, the method comprising:
providing a system comprising:
   a first substrate comprising a flow pass, the flow pass comprising at least one inlet and at least one outlet; and
   a second substrate covering the flow pass;
wherein at least a portion of a surface of the first substrate, of the second substrate or of a combination thereof comprises a ferromagnetic or paramagnetic material, the ferromagnetic or paramagnetic surface portion defines a boundary of the flow pass;
introducing a fluid sample to the flow pass through the inlet; and
collecting, at predefined times the eluted compounds from said outlet.

In some embodiments, the invention provides a method for separating chiral compounds present in a fluid sample, the method comprises:
providing a system comprising a flow pass comprising (e.g. filled with) ferromagnetic or paramagnetic particles, wherein the flow pass comprising at least one inlet and at least one outlet, wherein the particles are:
partially coated by an enantiomer of organic chiral molecule so that only one pole of the magnetic dipole of the particles is coated and the other is exposed to the solution; or
partially coated by a non-magnetic material, wherein one magnetic pole is coated by the non-magnetic material while the other is exposed to the solution; or
adsorbed to a net-like substrate enabling flow through the net-like substrate; which are further magnetized;
introducing the fluid sample comprising chiral compounds to the flow pass through the inlet; and
collecting, at predefined times the eluted compounds from said outlet.

In some other embodiments, the particle's coating by a non-magnetic material may be performed outside the flow pass. In some other embodiments, the particle's coating by an enantiomer of organic chiral molecule is performed by flow of the enantiomer through the flow pass of the system of this invention. In some other embodiments, the particles are partially or fully coated and cleaned to be exposed from one side. In further additional embodiments, when the particles are paramagnetic, a magnetic field is applied along the flow pass and thereby aligning the spins of the particles.

According to some additional embodiments the system may be in the form of a column channel, said column comprises an array of net or net-like substrates or grid substrates, positioned perpendicular to the flow direction, said substrate comprises a paramagnetic or ferromagnetic film deposited on the nets/grids or plurality of ferromagnetic or paramagnetic particles attached thereto. Fluid carrying chiral molecules may be passed through the column to thereby allow molecules interaction with the magnetized paramagnetic or ferromagnetic layer of particles held on the nets/grids.

In other embodiments, the methods of this invention comprise separation of chiral compounds, wherein the separation comprises adsorption of at least one chiral compound to the ferromagnetic or paramagnetic material, thus delaying elution of the chiral compound, thus separating the chiral compound from the fluid sample. In other embodiments, the adsorption is a result of spin-spin interaction between the ferromagnetic/paramagnetic material and the chiral compound. In other embodiments, the spin-spin interaction is based on spin polarization occurring in the compound molecules as a result of chiral induced spin selectivity (CISS) effect.

In other embodiments, the methods of this invention comprise separation of chiral compounds, wherein the separation of chiral compounds comprises a separation between enantiomers, separation of a chiral compound from a mixture of chiral and non-chiral compounds, separation of different compounds based on their overall chirality, separation between chiral secondary structures having no asymmetric carbon or separation between different secondary structures of proteins. In some embodiments, the invention provides a system for crystallization of a chiral structure, a system to enhance crystallization of a chiral structure, and/or a system for enantio-selective crystallization of a chiral compound comprising:
a surface on which a liquid solution is incubated, wherein the liquid solution comprises a mixture of enantiomers or a mixture of chiral and achiral compounds; and
   wherein the surface is configured with at least a portion comprising a ferromagnetic or paramagnetic material; wherein the ferromagnetic or paramagnetic material is permanently magnetized with a magnet dipole pointing up or down; or a magnet is located in vicinity to the surface with a magnetic field pointing either up (H+) or down (H−) with respect to the surface.

In some embodiments, the invention provides a system for induction of supramolecular chirality comprising:

a surface on which a liquid solution comprising an achiral compound is incubated, the surface is configured with at least a portion comprising a ferromagnetic or paramagnetic material; wherein the ferromagnetic or paramagnetic material is permanently magnetized with a magnet dipole pointing up or down. The permanent magnet is located in vicinity to the surface with a magnetic field pointing either up (H+) or down (H−) with respect to the surface.

In some embodiment, this invention provides a method for crystalizing a chiral compound from a mixture of chiral and achiral compounds; a method for enantio-selective crystallization of a chiral compound from a racemic mixture or a mixture of enantiomers; a method for enhancing the rate of enantio-selective crystallization;
the methods comprise:
incubating a liquid solution on a surface, for a sufficient amount of time to allow formation of crystals, wherein the liquid solution comprises a chiral compound; and wherein the surface is magnetized with a magnet dipole pointing up or down and wherein at least a portion of the surface comprises a ferromagnetic or paramagnetic material;
wherein said crystals are chiral.

In some embodiments, this invention provides a method for induction of supramolecular chirality of an achiral compound, the method comprises:
incubating a liquid solution comprising an achiral compound on a surface, for a sufficient amount of time to allow formation of supramolecular structures, wherein the surface is magnetized with a magnet dipole pointing up or down and wherein at least a portion of the surface comprises a ferromagnetic or paramagnetic material;
wherein said supramolecular structures are chiral.

In some embodiments, the crystallization from a racemic mixture is performed to yield a chiral crystal, even when naturally the enantiomers tend to form racemic crystals.

In some embodiments, the liquid solution comprises an achiral compound capable of forming supramolecular chiral structure in a solid state and the organization of said compound yields a chiral supramolecular structure.

It should be noted that the term “flow pass” referred herein above to a channel, surface or a column. Further according to the present technique, at least a portion of it comprises a ferromagnetic or paramagnetic material. The term ferromagnetic or paramagnetic material, referred herein to a bulk (continuous) ferromagnetic or paramagnetic material, a coating layer of a ferromagnetic or paramagnetic material or to plurality of particulate material. It should be noted that such particulate material may be of macroscopic size as well as comprise nano and micro particles. Thus, in some embodiments, at least a portion of the channel, surface, tube or column is a continuous/bulk ferromagnetic or paramagnetic material or comprises plurality of ferromagnetic or paramagnetic particles. In some other embodiments, the bulk ferromagnetic or paramagnetic material or the plurality of ferromagnetic or paramagnetic particles are coated with a conducting layer comprising a thin layer of non-magnetic metal like Au, Ti conductive semiconductor or any combination thereof to avoid oxidation of the ferromagnetic or paramagnetic material/particles. In other embodiments, the ferromagnetic or paramagnetic particles are well packed in the flow pass. In other embodiments, the ferromagnetic or paramagnetic particles are partially coated by a non-magnetic material or coated by an enantiomer of organic molecule or attached to a net-like substrate. The ferromagnetic materials may comprise material selected from Co, Fe, Ni, Gd, Tb, Dy, Eu, oxides thereof, alloys thereof or mixtures thereof.

In some embodiments, at least a portion of the first substrate, the second substrate or a combination thereof comprise a material selected from a non-ferromagnetic or paramagnetic metal, non-ferromagnetic or paramagnetic alloy, silicon/SiO₂, alumina, or an organic polymer. In some embodiments, the channel/flow pass is embedded in or in contact with a non-paramagnetic or non-ferromagnetic material such as non-ferromagnetic/paramagnetic metal, non-ferromagnetic/paramagnetic alloy, silicon/SiO₂, alumina, or an organic polymer.

In other embodiments, the system of this invention comprises a first substrate and a second substrate. In other embodiments, the non-ferromagnetic or non-paramagnetic portions of the first substrate or of the second substrate comprises an electrical conducting material such as a non-paramagnetic or non-ferromagnetic metal or alloy.

In some other embodiments, the non-ferromagnetic or non-paramagnetic metal comprises Ti, Zr, Cr, Mn, Fe, Zn, Al, or oxides thereof or any combination or alloys thereof. In another embodiment, the non-ferromagnetic or non-paramagnetic metal alloy comprises GaN or any other semiconductor or insulator or any combination thereof. In some other embodiments, the silicon comprises silicon (100), silicon (111), or any combination thereof. In another embodiment, the organic polymer may comprise polyethylene (PE), polypropylene (PP), polystyrene (PS) and polyvinyl chloride (PVC) or any combination thereof. In other embodiments, the ferromagnetic or paramagnetic portions and the non-paramagnetic or non-ferromagnetic metal/alloy are electrically connected to a power supply.

In some embodiments, the geometry of the flow pass of the system or the channel as employed in the methods of this invention comprises any possible structure that provides a separation of chiral compounds using the system of this invention. In another embodiment, the geometry is selected from a serpentine, a spiral or a linear geometry. In other embodiments, the channel/flow pass is a flow tube. In another embodiment, the length of the channel/flow pass is between 1 cm to 10 meters. In another embodiment, the length of the channel/flow pass is between 1 cm to 10 cm. In another embodiment, the length of the channel/flow pass is between 10 cm to 50 cm. In another embodiment, the length of the channel/flow pass is between 1 cm to 1 meter. In another embodiment, the length of the channel/flow pass is between 1 cm to 2 meters. In another embodiment, the length of the channel/flow pass is between 1 cm to 5 meters. In another embodiment, the length of the channel/flow pass is between 10 cm to 50 cm. In another embodiment, the length of the channel/flow pass is between 50 cm to one meter. In another embodiment, the length of the channel/flow pass is between 1 meter to 2 meters. In another embodiment, the length of the channel/flow pass is between 2 meters to 5 meters. In another embodiment, the length of the channel/flow pass is between 5 meters to 10 meters. In other embodiments, the channel is a microfluidic channel, or at least one dimension defining the cross-section of said channel is in the micrometer/submicrometer range.

In some embodiments, the inlet of the system is adapted for connecting to an element for controlling the speed of flow of the fluid in the channel/on the surface. In some embodiments, the system of this invention further comprises a flow control pump attached to the channel's inlet or outlet.

Thus, according to a broad aspect, the present invention provides a system for use in separation of chiral compounds comprising: a cavity configured for containing fluid mixture that comprising one or more types of chiral molecules, and at least one ferromagnetic or paramagnetic substrate providing at least one interface with said fluid mixture; wherein said at least one surface is magnetized providing magnetic field perpendicular to said ferromagnetic or paramagnetic interface.

According to some embodiments, said cavity may be in the form of a column allowing flow of the fluid mixture, said at least one surface is positioned along one or more regions of said column. The at least one ferromagnetic or paramagnetic surface may be positioned along one or more regions of said column being perpendicular to flow direction in the column.

Generally, flow rate of chiral molecules within the fluid mixture being affected by interaction variations with said ferromagnetic or paramagnetic interface, the interaction is associated with spin polarization formed by temporary adsorption of the chiral molecules onto said at least one surface.

According to some embodiments, the at least one ferromagnetic or paramagnetic substrate may comprise ferromagnetic or paramagnetic layer providing an interface with said fluid mixture on a selected polarity interface.

According to some embodiments, the at least one ferromagnetic or paramagnetic substrate comprises one or more ferromagnetic or paramagnetic particles providing one or more corresponding interfaces with said fluid mixture. The one or more ferromagnetic or paramagnetic particles may comprise a non-magnetic layer applied on one surface thereon thereby providing selected magnetic pole interfacing with said fluid mixture. The particles may be attached in groups to two or more particles, said two or more particles of a group being attached at non-magnetic end thereof, thereby providing effectively magnetic monopole particles.

In Some embodiments, the column comprising a matrix holding said particles in place within the column. The matrix may be in the form of a grid positioned perpendicular to flow direction in the column. Ferromagnetic or paramagnetic particles shaped as described herein and positioned on said grid may be aligned with ferromagnetic or paramagnetic layer thereof directed against flow through the column.

According to some embodiments, the one or more ferromagnetic or paramagnetic substrates may be one or more paramagnetic substrates, the system furthers comprising a magnetic field generator applying magnetic field onto the cavity to thereby magnetize said one or more paramagnetic substrates.

According to some embodiments, the column may comprise at least one grid section located within the column and allowing passage of said fluid mixture therethrough, grid of said at least one grid section carrying said at least one ferromagnetic or paramagnetic substrate being magnetized perpendicular to surface thereof and parallel or antiparallel with direction of flow through said at least one grid section.

According to some embodiments, the system may further comprise an electrode arrangement comprising at least first and second electrodes located on at least first and second opposing sides of the column, said first and second electrodes apply electric field applied on said fluid mixture perpendicular to the flow direction, in the channel. The electric field may increase charge polarization of the molecules and aligns the molecules. The electrode arrangement may be configured with said at least first and second electrodes located perpendicular to material flow through the column. The at least first and second electrodes may be of different dimension at least in one dimension thereof, thereby providing electric gradient within the cavity or column. The electrode arrangement may generally be configured with the smaller electrode located at side of the ferromagnetic or paramagnetic substrate to provide the electric field gradient larger at vicinity of said at least one ferromagnetic or paramagnetic substrate as compared to distant regions of the cavity.

According to some other embodiments, the fluid mixture being in gas state, said cavity may be configured as a vacuum chamber comprising an injection port and an ejection port, said at least one substrate having surface positioned within general direction of propagation of gas injected into the cavity through said injection port, and aligned to reflect particles toward a path to said ejection port.

The vacuum chamber may comprise two or more substrates positioned to define a path for molecules propagating by specular reflections between said substrates from the inlet port toward the outlet port of the vacuum chamber.

According to some embodiments, the system may comprise two or more surfaces in the vacuum chamber, said surfaces providing ferromagnetic or paramagnetic interface with said gas mixture. The two or more surfaces may be arranged in a cascade order for reflecting particles impinging thereon toward said ejection port.

According to some embodiments, the cavity may further comprise a pumping port associated with a vacuum pump removing excess gas from said chamber. Typically, excess gas may comprise chiral molecules randomly scattered from one or more surfaces after being adsorbed on said one or more surfaces.

According to some embodiments, the system may be configured for separating chiral molecules of said gas utilizing specular reflection of molecules having low adsorption affinity to said least one surface, while molecules having higher adsorption affinity scatter within the chamber away from said ejection port.

According to some other embodiments, the cavity is configured for allowing selected molecules of the fluid mixture to crystalize on interface with said at least one surface.

The cavity may comprise at least first and second regions comprising at least first and second surfaces, said first and second surfaces having opposite magnetization perpendicular to interface of the first and second surfaces, said cavity thereby enables crystallization of two different enantiomers of chiral molecules separately at the first and second regions. According to some embodiments, the fluid mixture is allowed to crystalize from liquid or gas phase.

According to one other broad aspect, the present invention provides a method for separating chiral molecules, the method comprising providing a fluid mixture comprising at least one type of chiral molecules, providing a substrate having magnetization in direction perpendicular to surface of the substrate being up or down with respect to the surface, flowing said mixture onto of said substrate for a given time period to allow molecules of the mixture to interact with said surface, thereby at least partially separating said at least one type of chiral molecules. The at least one type of chiral molecules may comprise different enantiomers of a type of chiral molecules.

According to some embodiments, the fluid mixture may comprise at least two types of chiral molecules, having different molecule structure.

The method may further comprise applying electric field in direction perpendicular to said surface thereby increasing charge polarization of molecules in said fluid mixture.

According to some embodiments, the method may comprise providing a plurality of substrates having magnetization in similar direction perpendicular to surface of the substrate being up or down with respect to the surface, and flowing said mixture onto said substrates one by one to thereby allow molecules of one type of enantiomer to interact on said substrate.

The method may further comprise flowing said fluid mixture in a channel having at least one region of interface with said substrate, thereby providing variation in flow rate for the different enantiomers of said at least one type of chiral molecules.

According to yet another broad aspect, the present invention provides a system for separating chiral molecules, the system comprising a column configured for passing material flow, said channel comprises at least one region comprising magnetic interface region interfacing with material flow through said channel; said interface region being magnetized at direction perpendicular to said interface thereby introducing variation in adsorption energy between chiral molecules of different enantiomers and said interface.

According to some embodiments, the magnetic interface region comprises a structured substrate comprising at least one magnetized layer being magnetized at direction perpendicular to said interface.

According to some embodiments, the magnetic interface region comprises a conducting layer at direct interface with material flow in the column.

According to some embodiments, the column comprises a plurality of magnetic interface region along material flow through the column.

According to some embodiments, the magnetic interface region is further associated with an electrode arrangement comprising at least first and second electrodes and configured for applying electric field at vicinity of said interface region, said electric field being directed perpendicular to flow in said column, being substantially parallel or anti-parallel with magnetization direction at said interface.

The first electrode may bei located in or below said magnetic interface region with respect to the channel, the second electrode located at other end along cross section of the channel. The second electrode may be larger than the first electrode with respect to at least one of length and width of the column.

According to some embodiments, the at least one region comprising magnetic interface region comprises one or more ferromagnetic or paramagnetic particles each having a non-magnetic layer applied on one surface thereon thereby providing selected magnetic pole interfacing with said fluid mixture.

The particles may be attached in groups to two or more particles, said two or more particles of a group being attached at non-magnetic end thereof, thereby providing effectively magnetic monopole particles.

According to some embodiments, the column may comprise a matrix holding the particles in place within the column. The matrix may be in the form of a grid positioned perpendicular to flow direction in the column. The particles on said grid may be aligned with ferromagnetic or paramagnetic layer thereof directed against flow through the column.

According to yet some embodiments, the column comprises one or more grid elements positioned across cross section of said column, said one or more grid sections carrying said at least one magnetic interface region.

The one or more grid sections may be coated by ferromagnetic material to provide said at least one magnetic interface region. Additionally or alternatively, the one or more grid sections may be carrying a plurality of magnetic particles, said plurality of magnetic particles being configured to interface said liquid mixture on one selected magnetic polarity thereof.

According to yet another broad aspect, the present invention provides a system for separating chiral molecules, the system comprising a vacuum chamber comprising inlet and outlet ports and one or more magnetized substrates; said one or more magnetized substrate being positioned and oriented to define path from particles propagation from said inlet port, by specular reflection from said one or more magnetized substrates, toward the outlet port.

The one or more magnetized substrates may be magnetized perpendicular to main surface of each substrate, said main surface is defined by surface on which particles impinge along said defined path.

According to some embodiments, the one or more magnetized substrates may comprise one or more structured substrates comprising at least one ferromagnetic or paramagnetic layer being magnetized at direction perpendicular to main surface thereof.

According to some embodiments, the one or more magnetized substrates may comprise a conducting layer applied on main surface thereof, said main surface is defined by surface on which particles impinge along said defined path.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 schematically illustrates a system for use in separation of chiral compounds/molecules according to some embodiments of the invention;

FIG. 2 illustrates a channel system for separation of chiral molecules according to some embodiments of the invention;

FIG. 3 illustrates an interaction region utilizing gradient electric field for separation of chiral molecules according to some embodiments of the invention;

FIGS. 4A to 4C illustrate a technique for providing interface with magnetic particles according to some embodiments of the invention, FIGS. 4A and 4B illustrate examples of magnetic particles configured to provide interface with selected magnetic pole, FIG. 4C exemplifies magnetic particles adsorbed or deposited on grids suitable for use in a column according to some embodiments of the present invention;

FIG. 5 illustrates a system for separation of chiral molecules in gas phase according to some embodiments of the invention;

FIG. 6 illustrates an additional configuration of a system for separation of chiral molecules by crystallization according to some embodiments of the invention;

FIGS. 7A to 7D show experimental results indicative of variation in adsorption rate of AHPA-L chiral molecules on magnetized surface, FIG. 7A shows 2 minutes adsorption with up magnetization; FIG. 7B shows 2 minutes adsorption, with down magnetization; FIG. 7C shows 2 seconds adsorption with up magnetization; and FIG. 7D shows 2 seconds adsorption with down magnetization;

FIGS. 8A and 8B show measured IR fluorescence spectra measured from adsorbed double stranded DNA on 8 nm thick gold coated Ni (7 nm) with the magnet pointing “up” and “down”, FIG. 8A shows IR fluorescence spectra for different adsorption times, and

FIG. 8B shows changes in the height of maximal fluorescence peaks at 620 nm as function of adsorption time:

FIGS. 9A-9E show AHPA-L adsorption of MBE grown ferromagnetic surface with the magnetic dipole pointing up (H+) or down (H−), FIG. 9A shows adsorption after 2 seconds with up magnetization; FIG. 9B shows adsorption after 2 seconds with down magnetization; FIG. 9C shows adsorption after 2 minutes with up magnetization; FIG. 9D shows adsorption after 2 minutes with down magnetization; and FIG. 9E shown number of adsorbed molecules measured in FIGS. 9A to 9D;

FIGS. 10A-10E show AHPA-D adsorption on ferromagnetic surface similar to FIGS. 9A to 9E; FIG. 10A shows adsorption after 1 second with up (+3000 G) magnetization; FIG. 10B shows adsorption after 1 second with down (−3000 G) magnetization; FIG. 10C shows adsorption after 10 minutes with up (+3000 G) magnetization; FIG. 10D shows adsorption after 10 minutes with down (−3000 G) magnetization; and FIG. 10E shows histograms of AHPA-D adsorption numbers based on FIGS. 10A to 10D;

FIGS. 11A to 11E show additional experimental measurement of AHPA-L adsorption of magnetized surface; FIG. 11A shows adsorption after 1 second with up (+3000 G) magnetization; FIG. 11B shows adsorption after 1 second with down (−3000 G) magnetization; FIG. 11C shows adsorption after 2 minutes in up (+3000 G) magnetization; FIG. 11D shows adsorption after 2 minutes with down (−3000 G) magnetization and FIG. 11E shows histograms of number of AHPA-L molecules adsorbed in the measurement of FIGS. 11A to 11D;

FIGS. 12A and 12B show Circular Dichroism (CD) spectra of L-alanine and D-alanine in solution after different separation techniques; FIG. 12A shows measured CD spectra for two solutions, separated using up (H+) and down (H−) magnetization according to some embodiments of the present technique; FIG. 12B shows CD spectra after repeating the separation technique steps to provide enantiomerically pure solutions;

FIG. 13 shows an image of separated crystallization of chiral molecules according to some embodiments of the invention;

FIG. 14 shows measured CD spectra for the different crystals formed in FIG. 13.

FIGS. 15A and 15B show measured IR absorption of adsorbed L-oligopeptides on a substrate at different conditions for two minutes including electric field applied on between the substrate and the cavity; FIG. 15A shows selected magnetization and electric potential measurement and FIG. 15B shows additional magnetization and electric potential measurements.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

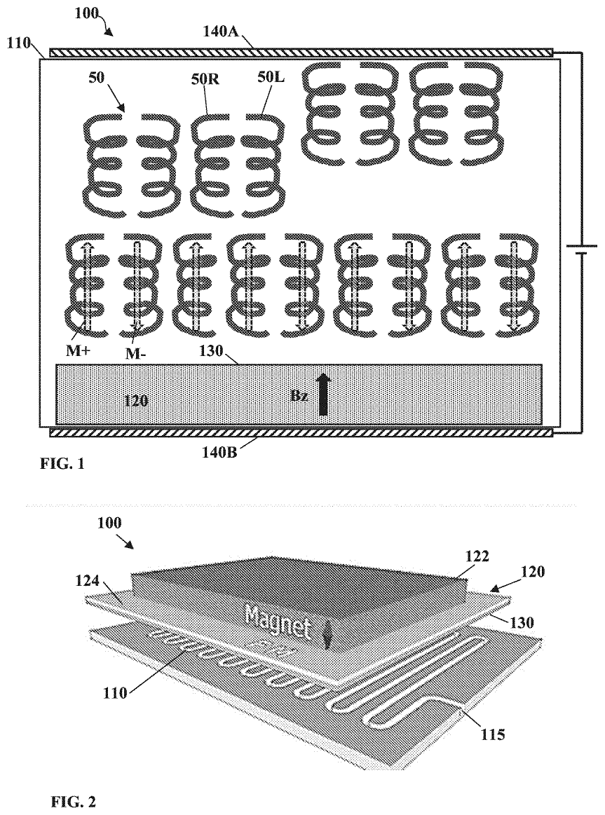

As indicated above, the present invention provides a technique enabling separation of chiral molecules into selected enantiomers. The present technique utilizes variation in interaction energy generated by the difference in interaction energies between the two enantiomers of a chiral molecule and a substrate magnetized perpendicular to its surface. Reference is made to FIG. 1 schematically illustrating a system 100 for use in separation of chiral molecules according to some embodiments of the present technique. System 100 includes a cavity 110, and at least one substrate/surface 120 providing suitable interface 130 with fluid medium in the cavity 110. The cavity may be configured as a column for liquid transmission vacuum chamber, or other configuration for holding and/or allowing flow of fluid liquid medium. The fluid is general transmitted through the cavity 110, or allowed to be held for selected time, and contains the mixture of enantiomers 50 of one or more types, such as chiral molecules 50R and 50L indicating different enantiomers of a type of chiral molecules. Additionally, in some configurations, the system may also include electric field generating module, exemplified by two electrodes 140A and 140B. The electric field generating module, when used, is configured to apply electric field directed to or from the substrate 120. This electric field provide certain alignment of the molecules with respect to interface 130 as well as increases charge polarization of the molecules and when there is a gradient in the field, it may cause the directing of the molecules towards the surface.

The at least one surface 120 includes at least one layer of ferromagnetic or paramagnetic material,) and configured to be magnetized in a direction perpendicular to the interface 130 with the medium in the cavity 110. The material may include magnetic particles such as micro or nano particles (sizes 10 nm-1 mm) or macroscopic layer of magnetic material. The particles may magnetize in the direction of the flow or with one magnetic pole covered or ordered as a monopole. In the specific example of FIG. 1 the surface 120 is magnetized as indicated by Bz, being upward or downward with respect to the interface 130. When molecules 50 reach close proximity to the interface, surface-molecule interactions generate electric polarization (electric dipole) of the molecules. The chiral structure of the molecules 50 results in preference for transmission of charge (e.g. electrons) having one spin over the opposite spin, which results in the charge polarization being accompanied with spin polarization. Accordingly, for a short time, molecules 50 that get close to the interface 130 have an electron's spin, associated with the electric pole close to the surface, aligned in directions toward M− the interface 130 or away M+ of the interface 130 depending on the molecular handedness. The spin polarization of molecules of different enantiomers result in differences in interaction energy with the magnetized surface 120. More specifically, the interaction energy of the magnetized surface (or its interface 130) with a specific group in the molecule 50 depends on their relative spin polarization. When the spin polarizations are aligned so that it is substantially parallel to the spin alignment in the magnetic substrate, the interaction energy is lower than when the spins are opposite. The variations in interaction energy results in corresponding variation in interaction time (and/or adsorption rate) of the molecules onto the interface 130.

The present technique utilizes such variation in adsorption rate of the chiral molecules 50 on the magnetized interface 130 for separation of the molecules based on chirality. Reference is made to FIG. 2 illustrating one possible configuration of system 100 for separation of chiral molecules according to some embodiments of the invention. In this configuration, the cavity 110 is in the form of a column or channel configured for allowing flow of liquid medium including at least one type of molecules, the column is configured with inlet 115 and outlet (not specifically shown) ports. The column is configured to provide at least one region of interface 130 between the liquid medium and magnetized surface/substrate 120. The column 110 is configures to allow flow of fluid mixture containing chiral molecules of at least one type (typically at least two enantiomers of chiral molecules or at least two different chiral molecules), while being in contact with substrate 120 at the interface 130. Generally, the fluid mixture may be pushed through the column 110 using a pump, or by placing the system at an angle causing gravity to pull the mixture through the channel. While the fluid mixture flows through the column 110, molecules are adsorbed and released from the interface 130 at corresponding rates. As molecules adsorb more onto the surface. Their flow rate become slower, while molecules of the opposite handedness adsorb for shorter time (or do not adsorb) have higher flow rate. Generally, the adsorption rate depends of interaction energy and temperature. As indicated above, chirality of the molecules and magnetization of the surface 120 result in variation in interaction energy for different enantiomers, which affects flow rate variations between the different enantiomers. Thus, when a selected amount of fluid mixture containing chiral molecules, e.g. mixture of the two or more enantiomers or two or more types of different chiral molecules, is introduced into the column 110 and in accordance with flow rate of the fluid through the channel, first portion of the fluid collected includes greater concentration of one enantiomer (or one type of chiral molecules) and second portion includes higher concentration of another enantiomer or another type of chiral molecules. The process may be repeated several times to provide desired purity of single enantiomer (or type of chiral molecules) from a mixture.

An exemplary configuration of the system 100 illustrated in FIG. 2, the surface 120 is formed of a ferromagnetic Cobalt (Co) flat layer magnetized perpendicular to the interface, at direction up or down. The coating may be fabricated using molecular beam epitaxy or (MBE) any other coating technique. The layered structure 120 is placed/deposited on a channel 110, e.g. curved within a solid substrate of non-magnetic or material, preferably electrically non-conducting, such that one face of the channel interfaces directly with layered structure 120.

In this connection the present technique and the system described in FIG. 2 may be used for separation chiral molecules in a technique that may resemble pot still distillation. More specifically, the present technique provides for separating mixture of one or more types of chiral molecules by providing the mixture, transmitting the mixture through system 100 while magnetization of surface/substrate 120 is selected to be up or down with respect to the interface 130. As indicated, magnetization of the substrate 120 results is difference in adsorption rates of the different enantiomers (or different chiral molecules) leading to corresponding variation in flow rate. Collecting a selected portion of the fluid after passing through the channel 110 provides increase concentration of one type of molecules over the other. Repeating this process several times enables to reach desired purity of the medium.

Generally, the column 110 may be associated with interface 130 with the magnetized substrate 120 throughout one or more regions of the column 110. These one or more regions may form a continuous interface region of spaced apart segments of the column 110.

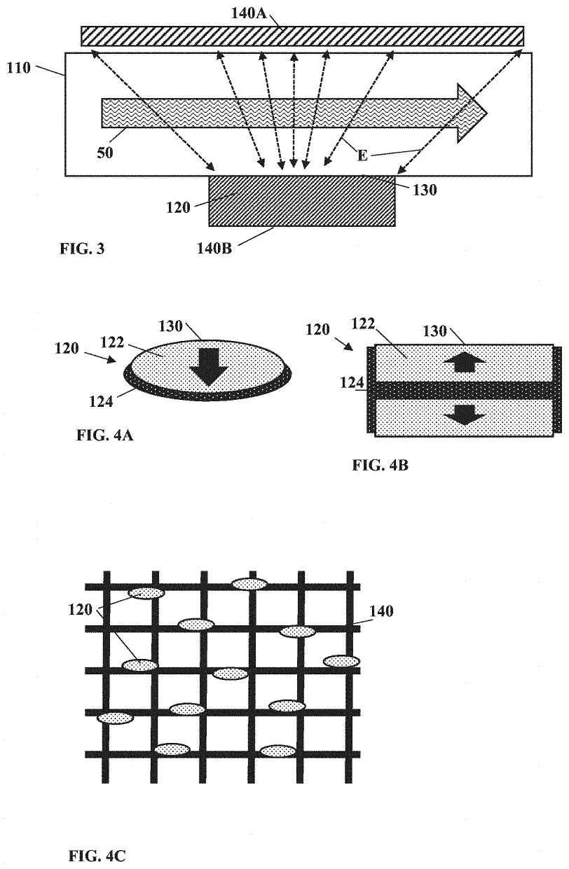

An additional configuration is exemplified in FIG. 3 schematically illustrating a section of the system including channel 110. Electrode arrangement 140A and 140B. The electrodes 140A and 140B are arranged such that electrode 140B is located at vicinity of the magnetized substrate 120 (electrode 140B may be the substrate 120 or separated therefrom) and electrode 140A is configured to be of larger dimension, e.g. wider perpendicular to the direction of flow of fluid mixture 50 through the column 110. This configuration provides gradient of electric field, represented by electric field lines E. The gradient in electric field causes at least one of, and generally both of electric polarization (which in response generates spin polarization) in the molecules and pushes the molecules towards the magnetic substrate 120. This configuration can be used also in combination of microfluidic assembly that allows to separate small amounts of the liquid mixture containing both enantiomers. This may increase the different in interaction between chiral molecules or different enantiomers (or different chiral molecules) and the magnetized interface 130 by 2-3 folds. Generally, a system for separation of chiral molecules may utilize one or more sections such as exemplified in FIG. 3 positioned along a channel to increase variation in flow rate between different molecules.

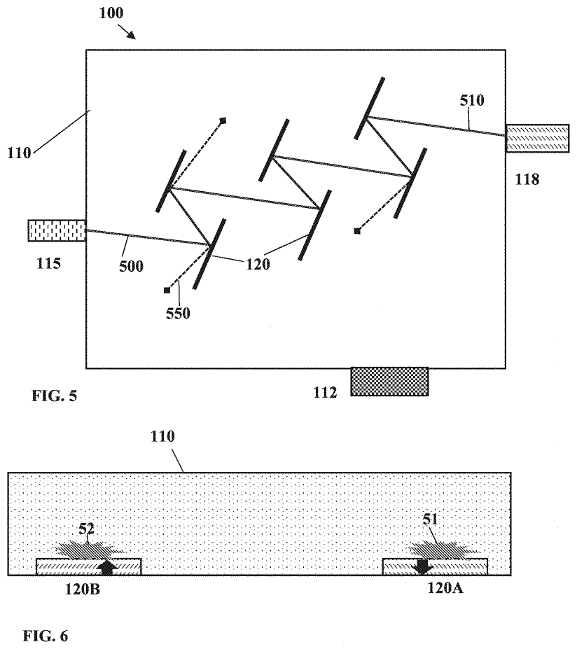

In some configurations, the column may be configured to provide interface of the liquid mixture with a ferromagnetic or paramagnetic substrate as exemplified in FIGS. 2 and 3. In some additional configurations the present technique may utilizes various other interface configurations in the form of plurality of particles providing corresponding plurality of interfaces with the liquid mixture. or of grid through which the liquid mixture is flowing. In this connection reference is made to FIGS. 4A to 4C exemplifying a use of ferromagnetic or paramagnetic particles for separation of chiral molecules in a column. FIGS. 4A and 4B exemplify particles' 120 configured to maintain interface 130 associated with one selected magnetic pole. More specifically, one magnetic pole is selected to interface with the liquid mixture in the column, while the opposite magnetic pole is shielded to minimize interaction with the material in the mixture.

The particles, 120 are generally configured from magnetized ferromagnetic material 122 coated along at least one surface thereof with non-magnetic (diamagnetic) material 124, or material having high magnetic susceptibility. The coated surface is selected in accordance with polarity of the magnetic particle 122 such that either one of the north or south pole is exposed, while the opposite pole is covered. In the example of FIG. 4B, two coated particles are attached together to effectively act as monopole particles, where only surfaces of one selected polarity are exposed to interact with the liquid mixture. Generally, such monopole particles may be formed by two, three, four, or more coated particles attached together to maintain surfaces of selected polarity directed outside. Such particles may be produced by coating a layer of magnetic material on one end with a layer of non-magnetic material, cutting the structure to selected sizes and attaching the different pieces to provide selected polarity.

FIG. 4C exemplifies the use of a grid structure 140 configured for holding the magnetic particles 120 within a column. The grid 140 is generally made from diamagnetic materials and is shaped to fit the internal side of the columns where it is used. In the example of FIG. 4C, the grid 140 carrying a plurality of magnetic particles 120 as exemplified in FIG. 4A or 4B. In some other configurations, the grid 140 may be coated by a ferromagnetic or paramagnetic layer on one side thereof to provide magnetic interface with the liquid in the column.

When used, one or more grid 140 elements are positioned with a column to allow flow of liquid mixture through the grid 140 and provide interaction between the molecules in the liquid mixture and magnetic interface of the grid, or of particle 120 attached thereto. Generally, the use of magnetic particles allows interaction of molecules from the mixture with the selected interface 130 of the particles to affect variation in flow rate based on chirality and handedness of the molecules. In some configurations using coating of the grid 140 with paramagnetic material, the column may operate within magnetic field environment to provide selected magnetization of the grid 140.

In some other configurations of the present technique, the technique may be used for separation of chiral molecules from gas mixture. Reference is made to FIG. 5 illustrating an additional configuration of system 100 configured for separating chiral molecules (generally different enantiomers of a chiral molecule) from gas phase mixture to provide enantiomer purification of the mixture. The system 100 includes a cavity 110, configured as a vacuum chamber having inlet and outlet ports 115 and 118 respectively and vacuum pumping port 112. The cavity includes one or more magnetic substrates 120, six such substrates are exemplified in FIG. 5. The gas mixture is injected into the vacuum chamber 110 through the inlet port 115, and the molecules are scattered from each surface 120. The one or more surface substrates 120 are positioned to provide a path for molecules 500 injected through the inlet port 115, to be reflected from substrate 120 (generally by specular reflection) and directed toward the outlet port 118. For the enantiomers having weak interaction with the substrate, the scattering is almost specular, namely the exit angle, θ (relative to the surface normal), is almost equal to the collision angle −θ. These enantiomers are thus reflected along a selected path towards additional surfaces for additional collisions and toward the outlet port 118. Namely, molecules 500 having low adsorption rate (short collision time) are immediately reflected from the surfaces 120 and directed toward the outlet port 118, providing separation to desired enantiomer type 510 at the outlet port 118. Molecules having higher adsorption rate (long collision time) may at times adsorb onto one of the surfaces 120, when released, the direction of the released molecules 550 is generally random resulting in these molecules propagating in other directions 510 within the cavity 110 and eventually collected by vacuum pump 112.

This configuration is based on scattering molecules from ferromagnetic or paramagnetic surfaces, when the substrates are magnetized perpendicular to the surface, with magnetic field point up or down relative to the surface. Generally, there are two limits in molecules-surface scattering. In the elastic limit, the collision time is very short, and the molecules are reflected from the surface at the same angle with opposite sign relative to the surface normal (similar to specular reflection). In the other limit the interaction of the molecules with the surface is stronger, resulting in a relatively long collision time due to adsorption of the molecules on the surface. In this case the scattering of the molecules has a cosine shape angular distribution and single molecules typically scatter at random direction 550.

This effect may be used for separation of chiral molecules by injecting a beam of gaseous molecules through the inlet port 115 into the vacuum chamber 110. Generally, the molecules of the beam are injected with about the same velocity (with variations of up to 10%). The molecular beam 500 includes molecules of two enantiomers of a chiral molecular structure. When molecules of the molecular beam 500 collide with the surfaces 120, where all the surfaces 120 are magnetized in similar direction relative to interface with the colliding molecules. Magnetization of the surfaces 120 generates variation in interaction energy of the molecules of different enantiomers with the surfaces, resulting in molecules of one enantiomer being generally reflected from the surfaces, and molecules of the other enantiomer being interacting with the surface 120 and being scattered at random cosine-shaped distribution of directions 510. Accordingly, molecules of one selected enantiomer are sequentially reflected along the selected path 510 toward the outlet port, to be collected for enantiomer pure composition. This is while molecules of the other enantiomers are scattered in other directions 550 and collected by the vacuum pump 112. Typically, the shorter the interaction time so more elastic is the collision and higher is the transmission. Since the two enantiomers have different interaction strength with the substrate their transmission through the array will be different. Generally, selection of velocity of the injected molecular beam, and number of surfaces 120 in the cavity 110 as well as relative size of the outlet port 118 with respect to the beam width determine selectivity of the separation technique described herein. In some configurations, one or more additional slits may be used between scattering surfaces 120 for improved separation selectivity.

This technique enables continuous operation in separation of chiral molecules. As the molecules are separated to different paths, enantiomers of one handedness are collected via the outlet port 118 and enantiomers of the other handedness (at certain purity level) are collected via the vacuum pump 112. The system 100 as illustrated in FIG. 5 may be used in combination with a mass spectrometer system, as the molecules are introduced in gas phase.

According to yet additional configurations of the present technique, is may be used for separation of chiral molecules by selective crystallization of selected enantiomer from racemic mixture. Referring back to FIG. 1, the technique utilizes providing fluid mixture including enantiomers of chiral molecule such as 50R and 50L. The technique further includes maintaining suitable crystallization conditions to the fluid mixture and the molecules therein, in the presence of magnetized surface 120 having magnetization direction Bz being up or down with respect to the interface 130. The presence of magnetic substrate 120, and the variation of interaction energy between different enantiomers 50 and the substrate 120 as described above. This spin polarization of molecules 50 in vicinity of the interface 130 generates preference in interactions between molecules of the same enantiomers for creation of crystallization nuclei, allowing selective crystallization of one enantiomer over the other.

Generally, it should be noted that various chiral molecules types are known to generate enantiomer pure crystals, while other chiral molecules generate racemic crystals. According to the present technique, providing a magnetized substrate 120 at interface 130 with the mixture from which the material crystallizes, enable selection of the enantiomer that crystallizes and providing selective crystallization of one enantiomer over the other, even for molecules that generally provide racemic crystals. Reference is made to FIG. 6 exemplifying an additional configuration for separation of chiral molecules by crystallization. In this configuration, fluid mixture containing mixture of two enantiomers of chiral molecules is held in cavity 110, where the cavity also includes at least two substrates 120A and 120B, each magnetized perpendicular to interface of the substrate with the fluid. In this example, substrate 120A is magnetized down with respect to the interface and substrate 120B is magnetized up with respect to the interface. The mixture is allowed to crystalize within the cavity 110, where due to the variations in interaction energy promoted by magnetization of the substrates 120A and 120B, crystallization nuclei 51 and 52 are formed on the relevant interfaces. The formed crystallization nuclei are substantially enantiomerically pure and contain at least 60%, and preferably 90% or 99% of single enantiomer molecules.

The underlying features of the present technique as well as its effectiveness have been demonstrated by the inventors in various exemplary experimental configurations. The following examples are presented to more fully illustrate the embodiments of the invention and its ability to provide separation of chiral molecules in accordance with the above described technique.

### Example 1: The Effect of Magnetic Field Direction on Chiral Compounds

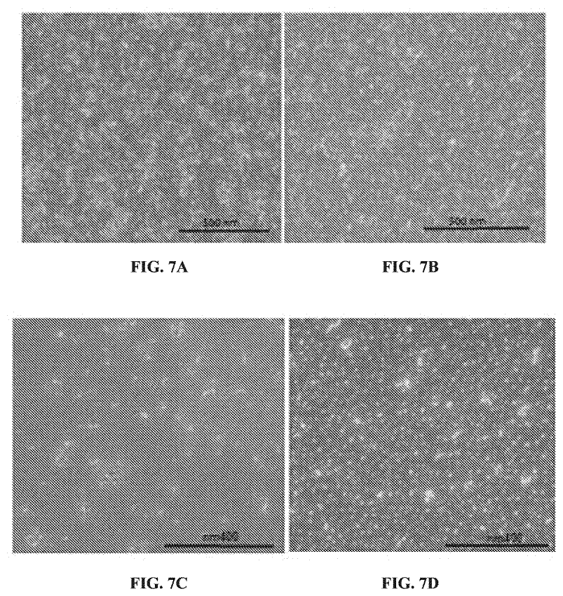

A solution including 1 nM of L-alpha helix polyalanine (AHPA-L SH-CAAAAKAAAAKAAAAKAAAAKAAAAKAAAAKAAAAK (SEQ ID 3)) was used for covalently adsorbing the AHPA-L to a ferromagnetic Cobalt film covered with 2 nm Gold. FIGS. 7A and 7B show microscope images of the film after AHPA-L was allowed to adsorb for 2 minutes with magnetic field of the cobalt film directed up (FIG. 7A) and down (FIG. 7B). FIGS. 6C and 7D show microscope image of the film after was allowed to adsorb for 2 seconds with magnetic field of the cobalt film directed up (FIG. 7C) and down (FIG. 7D). It should be noted that SiO₂ nanocrystals (0.5 wt %) were attached to the tail of the polyalanine to act as a marker for the monolayer adsorption density and provide increased visibility.

A clear difference is visible between adsorption of the AHPA-L based on time of adsorption and, for short adsorption time, based on direction of magnetization of the cobalt film. It can be clearly seen that although for longer adsorption time there is no visible difference in density of adsorbed molecules on the film. However, for short adsorption time the polyalanine-L was adsorbed better when the magnet was “down” (negative, perpendicular magnetic field directed towards the ferromagnetic surface) as shown in FIG. 7D, as compared to the adsorption when the magnet was “up” (positive, perpendicular magnetic field directed away from the ferromagnetic surface) as shown in FIG. 7C. The ratio between the densities of the molecules (detected by silicon oxide density) between FIG. 7C and FIG. 7D is about 1:100. Additionally, it is clearly visible that the adsorption of AHPA-L of the film with magnetization down (FIGS. 6B and 6D) is almost immediate, while the rate of adsorption of AHPA-L on the film with magnetization up (FIGS. 7A and 7C) is relatively slower.

For monitoring the kinetics of adsorption depend on the substrate direction of magnetization, as well as to test yet another kind of chiral molecule, the inventors used double-stranded DNA (dsDNA) molecules, to which a dye was attached, and examined adsorption thereof on Nickel/gold surface in different magnetization direction. For the fluorescence measurement, Cy-3 (cyanine) dye was tagged at the 3′ position (cytosine) of the dsDNA (20 bp). The linker Cy-3 modifies the phosphate of cytosine (purchased from Integrated DNA Technology (IDT)). The dsDNA sequence that was used was as follows:

(SEQ ID 1)
5- GAC CAC AGA T TC A AAC ATG C/3ThioMC3-D/ -3
(SEQ ID 2)
5-GCA TGT TTG AAT CTG TGG TC/3′Cy3Sp/-3

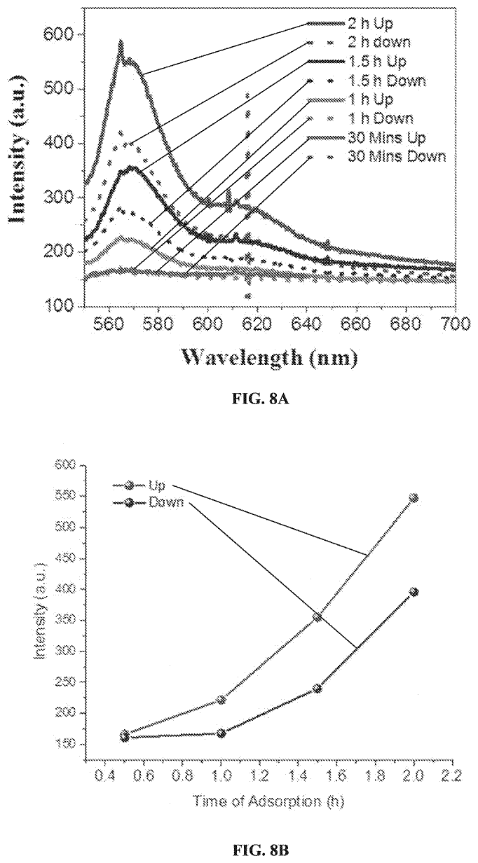

The molecules were adsorbed on a Ni/Au surface, FIG. 8A shows measures of fluorescence for different adsorption times and for different Ni magnetization directions. FIG. 8B shown intensity of peak wavelength fluorescence for the different magnetization along time. In the first hour, the ratio between the adsorption rates for the two magnetic directions was as high as one to ten, providing very high ratio, as compared to the conventional separation methods.

These results consistently show that the governing variation between adsorption of different enantiomers onto magnetized substrates is in the rate of adsorption. Given enough time the molecules will be adsorbed independently of their specific handedness and the direction of magnetization. These results are consistent with the above described model relating to spin polarization of the molecules. Specifically, the surface-molecule interaction is controlled by the spin-dependent exchange interaction. When a molecule approaches the substrate, it is charge polarized. As shown recently, charge polarization in chiral molecules is accompanied by spin polarization. Hence, the interaction energy of the ferromagnetic substrate with a specific group in the molecule depends on their relative spin polarization.

The DNA double stranded solutions for the SAM incubation were prepared using a functionalized double stranded DNA (purchased from Integrated DNA Technologies), having the following structure:

(SEQ ID 1)
5′ GAC CAC AGA TTC AAA CAT GC - Thiol-Modifier-C3
S-S 3′
and
(SEQ ID 2)
3′Cy3 - CTG GTG TCT AAG TTT GTA CG 5′

A 100 μM stock solution was prepared using deionized water as the solvent. The solutions for the SAM preparation were prepared by mixing 100 μL of the stock solution and adding 80 μL of a phosphate buffer 1 M (pH 7.2) solution and 20 μL water, to obtain 200 μL of a 50 μM DNA solution in 0.4 M phosphate buffer (pH 7.2). This solution underwent a PCR incubation (10 minutes at 90 C.°, then cooled down to 15 C.° at a ramp of 1 C.° each 45 sec) to form the double stranded helix. After this, 200 μL of a 10 mM Tris(2-carboxyethyl)phosphine hydrochloride (purchased from Sigma Aldrich) in 0.4 M buffer phosphate (pH 7.2) were added to the DNA solution to remove the thiol-protecting group, and the resulting solution was left reacting for 2 h. The product was purified by filtering the solution with a Micro Bio-Spin P-30 column (purchased from Bio Rad). The final concentration of the DNA solution is finally checked by UV-vis spectroscopy using a Nanodrop spectrometer, finding a 22 mM DNA concentration.

The adsorption experiments were performed using 1×1 cm² ferromagnetic samples (Si Wafer|80 Ti|1000 Ni|80 Au, units in A) as the substrates for the SAM formation. The surfaces were cleaned by boiling in acetone and in ethanol for 10 min each, then by exposure to a UV/OX treatment for 10 min and then by soaking into an ethanol bath for 30 min.

Immediately after drying them with a nitrogen flow, the surfaces were placed in a magnetic field of ±3000 G, directed away (+) or into (−) the surfaces. Different adsorption durations were tested for both magnetic orientations: <30 min, 1 h, 1.5 h, >2 h. Immediately after adsorption, samples were rinsed twice in phosphate buffer 0.4M (pH 7.2) and twice in DI water, without applying a magnetic field, in order to remove unwanted molecular residues, and then dried by nitrogen.

The fluorescence of the monolayers was measured using a LabRam HR800-PL spectrofluorimeter microscope (Horiba Jobin-Yivon). For the excitation of the dye, a 532 nm laser light (DJ532-40 laser diode, ThorLabs, at a power of ˜1.65 mW/cm²) was used. The spectra were collected using a microscope (with a ×10 high-working distance lens) from 9 different points (mapping from 3×3 matrix) and then averaged out. During the measurement, a confocal aperture (1100 μm) was fully opened, and the integration time was maintained at 15 sec.

### Example 2: The Effect of Magnetic Field Direction on Chiral Compounds AHPA-L and AHPA-D

Thiolated L- and D alpha helix polyalanine [AHPA-L and AHPA-D] enantiomers (SH-CAAAAKAAAAKAAAAKAAAAKAAAAKAAAAKAAAAK (SEQ ID 3)), were covalently adsorbed for 2 seconds on a ferromagnetic (FM) Cobalt film covered with 5 nm gold. In the sequence, C, A, and K represent cysteine, alanine, and lysine, respectively. SiO₂ nanoparticles (NPs) were attached to the tail of the adsorbed polyalanine to act as a marker for the monolayer adsorption density. Importantly, it is known that a thin layer of Nobel metal like gold or platinum (up to about 10 nm), deposited on a ferromagnetic substrate, transfers spin very efficiently and features generally diamagnetic properties and spin accumulation. Hence, the gold layer that prevents oxidation and ensures covalent bonding, can be viewed as part of the ferromagnetic substrate providing suitable adsorption interface.

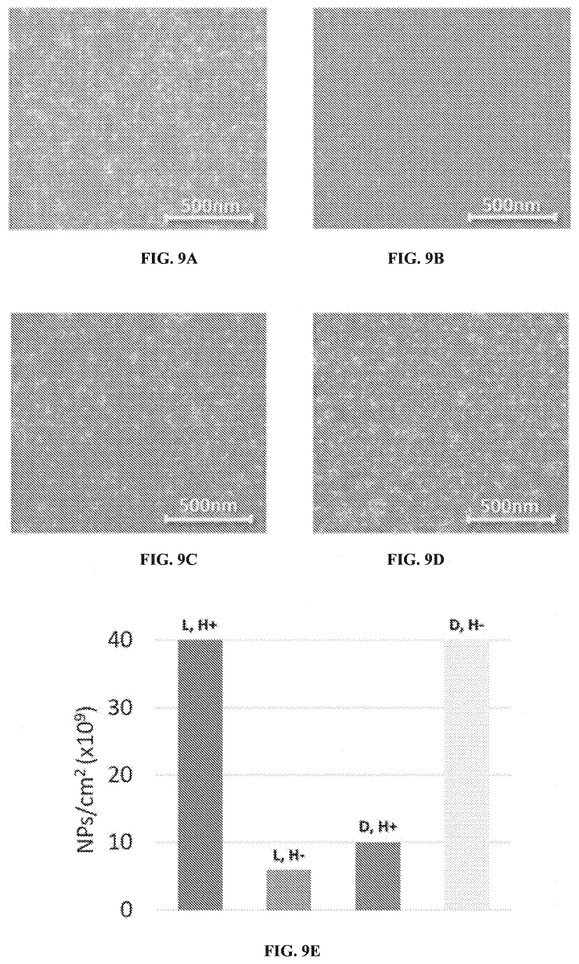

FIGS. 9A to 9D show SEM images of the adsorbed AHPA-L and AHPA-D molecules of the substrate with magnetization of ±3000 G, FIG. 9E shows density of adsorbed molecules for of FIGS. 9A to 9D. FIG. 9A depicts a SEM spectra of the adsorbed AHPA-L on the substrate (1.8 nm Co+5 nm Au) under +3000 G magnetic field to yield a concentration of ˜4·10¹⁰ NPs/cm², while applying −3000 G magnetic field shown in FIG. 9B, results in lower concentration of about ˜6·10⁹ NPs/cm². FIG. 9C depicts a SEM image of the adsorbed AHPA-D on the substrate (1.8 nm Co+5 nm Au) under +3000 G magnetic field to yield a concentration of ˜1·10¹⁰ NPs/cm², while applying −3000 G magnetic field the concentration was higher ˜4·10¹⁰ NPs/cm² as shown in FIG. 9D. A graph of the different adsorption densities is shown in FIG. 9E. It is clearly shown that by applying a magnetic field in one direction +3000 G, the AHPA-L enantiomer is better adsorbed to the FM surface, while applying a magnetic field in the opposite direction −3000 G the AHPA-D enantiomer is better adsorbed to the surface.

Repeating this experiment with a longer adsorption time (of about 2 minutes) caused a reduction in the enantio-selectivity of adsorption. These results indicate different adsorption rate for each enantiomer, depending on the direction of substrate magnetization. In one magnetization direction, the AHPA-L adsorption rate is at least 8 times faster than that of the AHPA-D, whereas in the other magnetization direction the AHPA-D adsorption rate is at least 4 times faster than that of AHPA-L. It is worth mentioning that the AHPA-D purification level is lower than that of AHPA-L, potentially explaining the asymmetry in adsorption rate ratios.

### Example 3: The Effect of Magnetic Field Direction on the Adsorption Time of AHPA-L and AHPA-D

1 mM of AHPA molecules in ethanolic solution were adsorbed by SAM method on a superparamagnetic (SPM) substrate (substrate layers of 100 Å Al₂O₃|20 Å TaN|30 Å Pt|1.5 Å Co|20 Å Au), while placed under an external magnetic field of ±3000 G at room temperature (RT) and under inert conditions. The magnetic field was applied perpendicular to the surface in up (+) or down (−) direction. Different adsorption durations were tested for both magnetic orientations: <1 sec, 2 sec, 10 sec, 20 sec, 30 sec, 1 min, 2 min and 10 min Immediately after adsorption, samples were rinsed in absolute ethanol, without applying a magnetic field, in order to remove un-adsorbed molecular residues, and then dried by nitrogen. The adsorption of the chiral compounds was immediate (1 sec), however, with increase of time to, for example, 10 min, the concentration of the compounds adsorbed on the surface increased.

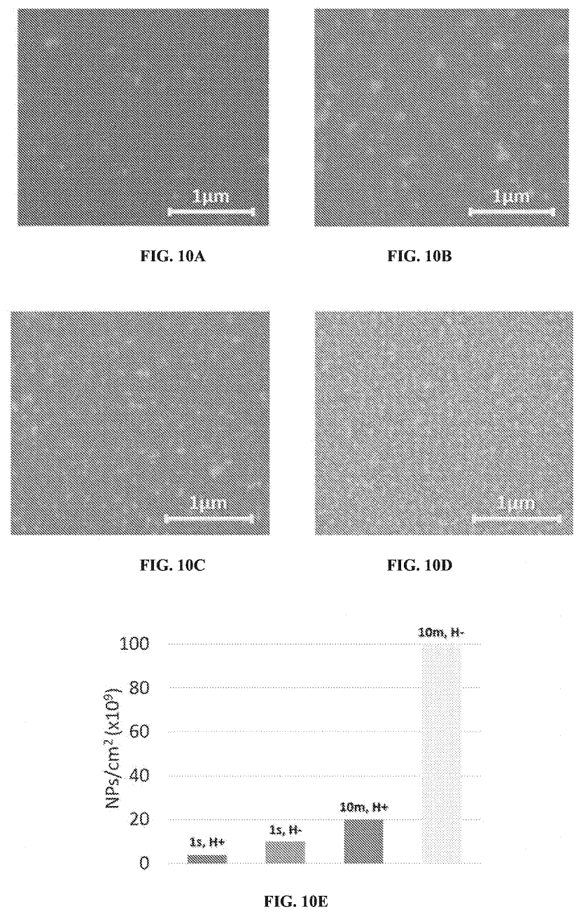

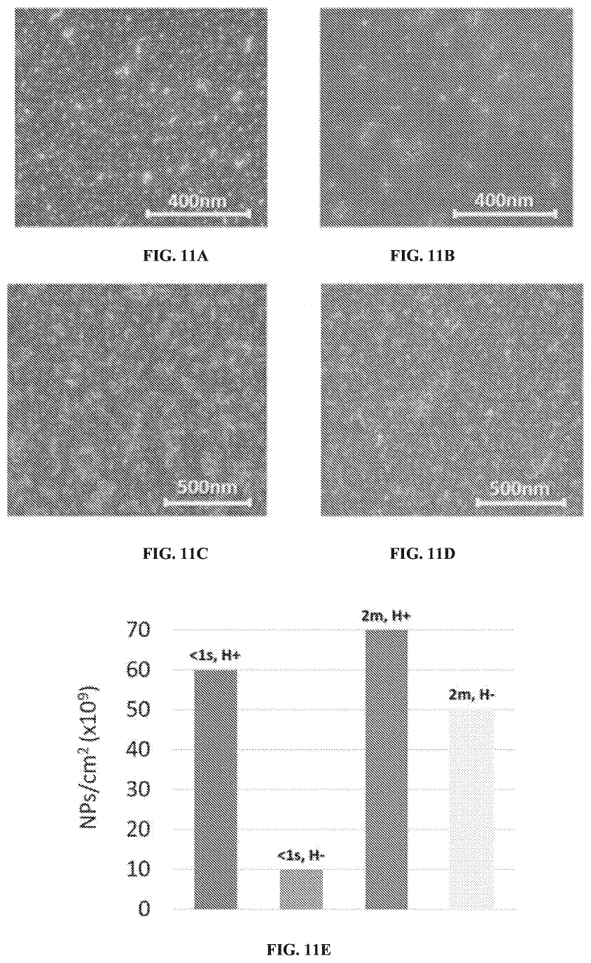

FIGS. 10A to 10E show adsorption results by SEM images (FIGS. 10A to 10D) and summarize the adsorption density (FIG. 10E). FIG. 10A shows adsorption of 1 mL ethanolic solution of 1 mM AHPA-D within 1 second under a +3000 G magnetic field, yielding a concentration of ˜4·10⁹ NPs/cm²; FIG. 10B shows adsorption of the same solution in similar condition but under a −3000 G perpendicular magnetic field, providing a concentration of ˜1·10¹⁰ NPs/cm². This process was repeated for a 10 min adsorption duration as a +3000 G (FIG. 10C) applied magnetic field gave a concentration of ˜2·10¹⁰ NPs/cm², and a −3000 G (FIG. 10D) perpendicular magnetic field resulted in a concentration of ˜1·10¹¹ NPs/cm². All samples were immersed in a solution of 0.15% wt SiO₂ NPs in water for 2 min and then dried. FIG. 10E shows the different adsorption density of FIGS. 10A to 10D, illustrating the increased adsorption rate of AHPA-D with magnetic field having “down” direction.

Similar time-dependent adsorptions were conducted on molecular beam epitaxy (MBE) grown epitaxial FM thin film magnetic samples with perpendicular anisotropy (Al₂O₃ (0001)|Pt 50 Å|Au 200 Å|Co 18 Å|Au 50 Å). The FM samples were magnetized by an external magnetic field of ±3000 G at room temperature and under inert conditions. The coercive field of the ferromagnetic substrates used was ˜215 G. The substrates' easy axis was out-of-plane (OOP) thus ensuring that the applied magnetic field reorients the magnetization OOP parallel or anti-parallel to surface normal.

All samples were then immersed in a solution of 0.15 wt % SiO₂ amorphous nanocrystals (NCs) in H₂O (mkNANO), without any magnetic influence, for 2 min, and then rinsed in H₂O. The NCs were used in order to mark the adsorbed molecules location on the substrate.

FIGS. 11A to 11D show microscopic images of the adsorbed molecules, FIG. 11E shows the adsorption densities of FIGS. 10A to 10D. Different superparamagnetic samples were immersed in a 1 mL ethanolic solution of 1 mM AHPA-L. FIGS. 10A and 10B show adsorption after 1 second under a +3000 G (FIG. 11A) perpendicular magnetic field yields a concentration of ˜6·10¹⁰ NPs/cm², and a −3000 G (FIG. 11B) perpendicular magnetic field yields a concentration of ˜1·10¹⁰ NPs/cm². This process was repeated for 2 min adsorption duration shown in FIGS. 11C and 11D as a +3000 G (FIG. 11C) perpendicular magnetic field yields a concentration of ˜7·10¹⁰ NPs/cm² and a −3000 G (FIG. 11D) perpendicular magnetic field yields a concentration of ˜5·10¹⁰ NPs/cm². FIG. 10E shows the density of adsorption in each of these tests. Again clarifying the variation in rate of adsorption resulting from spin polarization interaction with the magnetized substrate.

### Example 4: Separation of Chiral Compounds by Applying Magnetic Field

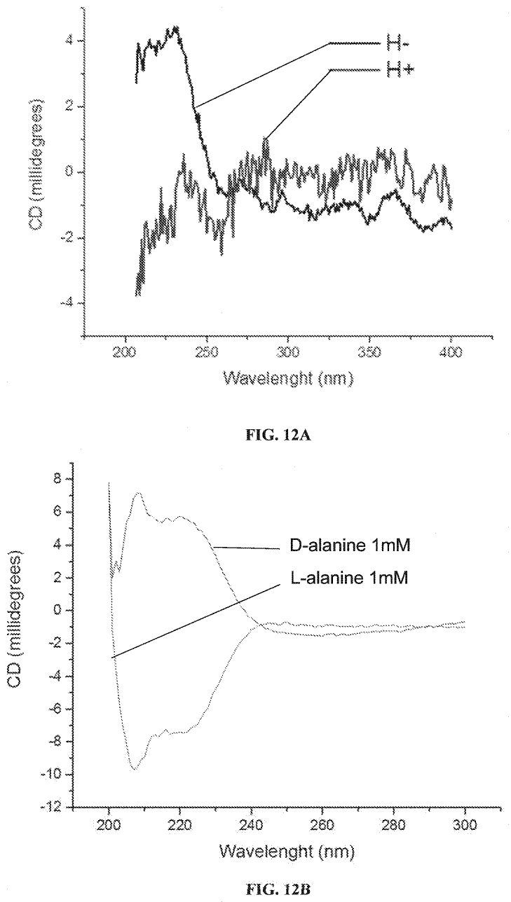

Racemic mixtures of polyalanine (as defined in Example 2) with no Circular dichroism (CD) spectra were separated by interaction with magnetic substrate (Ni coated by 10 nm Au) while passing through a column/channel as illustrated in FIG. 2. In the first experiment the substrate was magnetized with its magnetic field pointing “down” (negative, perpendicular magnetic field directed towards the ferromagnetic surface). As exemplified above in Examples 2-3, the D-alanine is being better adsorbed to the FM substrate by applying a magnetic field pointing down (−3000 G). In the second experiment the substrate was magnetized with its magnetic field pointing “up” (positive, perpendicular magnetic field directed away from the ferromagnetic surface). As exemplified above in Examples 3-4, the L-alanine was better adsorbed to the FM substrate by applying a magnetic field pointing up (+3000 G). Thus, by applying a magnetic field pointing up (+3000 G), the L-enantiomer was better adsorbed to the surface and the D enantiomer remains in solution. FIGS. 12A and 12B show CD spectra of the resulting solutions. FIG. 12A shows CD spectra of the obtained D-alanine after separation with “down” magnetization and that of the obtained L-alanine after separation with “up” magnetization. FIG. 12B shows CD spectra of D- and L-alanine obtained by repeating separation and provides comparison.

These results demonstrate the ability to separate a mixture of chiral molecules by magnetizing the substrate, with no specific enantio-recognition. Moreover, higher purification levels could be achieved with additional adsorption cycles.

CD Spectra Measurements

A racemic mixture of polyalanine (as defined in Example 2) consisted of 1 μM of AHPA-D and 1 μM of AHPA-L in an ethanolic solution was used. A 4×4 mm² superparamagnetic (SPM) sample was adsorbed in the racemic solution under the influence of a +3000 G external magnetic field for about 1 second. 1 ml from the remaining solution was transferred into a cuvette. This process was repeated with 99 additional 4×4 mm² SPM samples were adsorbed in the same solution. After 100 samples' adsorptions, an additional 1 ml was extracted from the remaining solution and placed it in a cuvette. The same procedure was repeated with a new racemic mixture for a −3000 G external magnetic field.

The Circular Dichroism measurements were carried out using a Chirascan spectrometer, Applied Photo Physics, England. The measurement conditions for all spectra were: Scan Range—210 to 400 nm; Time per point—2 second; Step size—1 nm; Bandwidth—1 nm.

The quartz cuvette used had an optical pathway of 1 cm.

### Example 5: Chiral and Enantio-Selective Crystallization

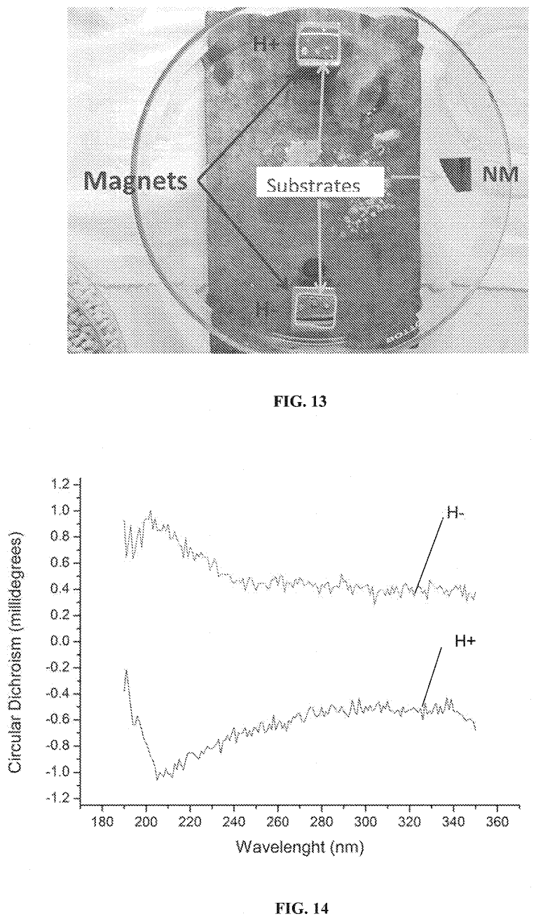

A method was developed, in which crystallization of enantio-selective crystals was induced by performing the crystallization on a substrate/surface which is magnetized perpendicular to its surface, when the magnet north pole was pointing either “up” or “down” relative to the surface. The magnetic substrate enhanced the crystal formation and caused a spontaneous separation between the crystals, so that one enantiomer was crystallized on a surface magnetized with the magnetic dipole pointing up from the surface while the other enantiomer crystallized on the magnetic surface when the magnetic dipole was pointing down relative to the surface. FIG. 13 shows a picture of the crystals formed with either a positive H+, negative H− or no magnetic field applied on the magnetic substrates in a system as illustrated in FIG. 5. While crystals were formed on the magnetized substrate/surface, no crystallization is observed on the unmagnetized one. The method was applied for various compounds without the need of specific seeding.

The present technique was demonstrated in an experiment using a supersaturated solution of DL-asparagine monohydrate. The solution was obtained by dissolving 300 mg of racemic mixture in 3 mL of water at 90° C. Then the solution was filtered hot through a syringe filter with pores of 0.02 μm directly on top of the magnetic surface. This surface consisted of a 150 nm of nickel layer, capped with 8 nm of gold to protect it from oxidation, evaporated by sputtering on top of a silicon wafer that serves as substrate. A magnetic field of 0.5 T was produced by a magnet located just below the substrate with the magnetic field pointing either upward (H+) or downward (H−). The solution was left incubating at 25° C. until the formation of few small crystals on top of the metallic surface (this process takes about 9 hours). The crystals were then taken out of the incubating solution, washed with a small amount of cold water and dissolved in 3.5 mL of water to measure the circular dichroism. FIG. 14 is CD spectra taken for solution made from crystals collected from the substrate magnetized up (H+) and for solution containing crystals collected from the substrate magnetized down (H−). From the CD intensity it can be concluded that each solution contains about 80% pure one enantiomer.

### Example 6: Addition of Electric Field

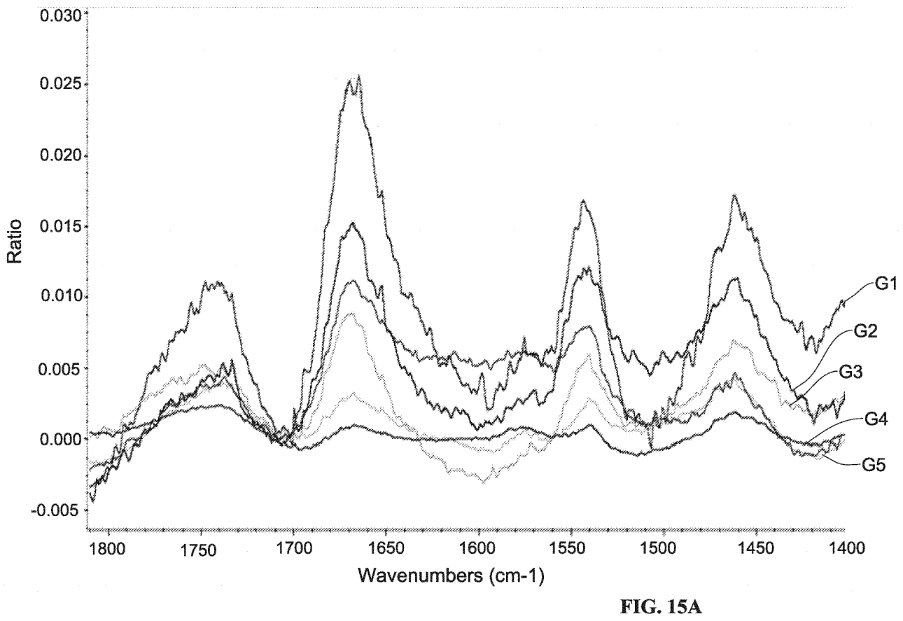

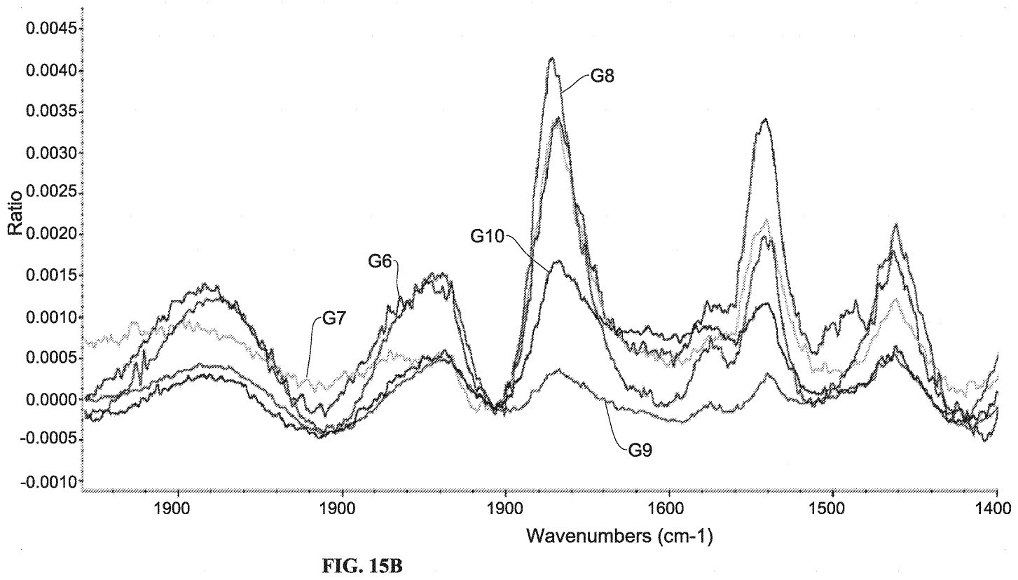

L-thiolated oligopeptide in aqueous solution was allowed to adsorbed on magnetized substrate (cobalt ferromagnetic layer with gold coating) under varying electric field conditions. FIGS. 15A and 15B show IR absorption of the adsorbed L-oligopeptides adsorbed of the substrate at the measured conditions for period of two minutes including in FIG. 16A: “down” magnetization with electric potential of 1V (G1); “down” magnetization with no electric potential difference (G2); no magnetization and no electric potential (G3); “up” magnetization with electric potential of 1V (G4); “up” magnetization with no electric potential (G5). FIG. 16B shows the IR absorption results for: no magnetization with electric potential of 2V (G6); no magnetization with electric potential of −1V (G7); “up” magnetization with electric potential of −2V (G8); “up” magnetization with electric potential of −1V (G9); and “up magnetization with no electric potential (G10). As shown, the peak absorption is found at the lines at 1668 and 1542 cm-1 where the absorption intensity is proportional to the number of adsorbed molecules. The strongest signal (greater amount of adsorbed molecules is found when the north pole of the magnet is pointing up and a field of −2 V (G8) and for magnet pointing down a filed of +1 V (G1).

These results show correlation between the magnetization direction of the magnetic substrate and the sign of the electric field. When the North pole of the magnet is pointing up the positive pole of the molecule interacts better with the substrate, while if the opposite magnet is applied, the negative pole of the molecule is interacting better with the substrate. Accordingly, corresponding electric field may increase the interaction. It should be noted that the relation between magnetization direction and electric field direction is specific to molecule types. More specifically, certain molecules may only have one end suitable for adsorption and may interact with the substrate by different charge polarization directions. The specific direction for electric potential difference associated with the magnetization direction may be determined for each type of chiral molecules. Based on the above experimental results, the use of electric field enhancement on top of magnetization selectivity in interaction between different enantiomers with magnetic substrate provide interaction energy variation increased by factor of 2-3 folds.

1. A system for use in separation of chiral compounds to corresponding enantiomers, the system comprising:
(a) a cavity configured for containing fluid mixture that comprising one or more types of chiral molecules;
(b) at least one ferromagnetic or paramagnetic substrate providing at least one surface interface with said fluid mixture;
wherein said at least one ferromagnetic or paramagnetic substrate is magnetized providing magnetization direction perpendicular to a surface of said at least one surface interface thereby providing variation in interaction energy between different enantiomers and said surface varying interaction properties therebetween.

2. The system of claim 1, wherein said cavity is in the form of a column allowing flow of the fluid mixture, said at least one surface interface is positioned along one or more regions of said column.

3. The system of claim 2, wherein said at least one ferromagnetic or paramagnetic surface is positioned along one or more regions of said column being perpendicular to flow direction in the column.

4. The system of claim 1, wherein flow rate of chiral molecules within the fluid mixture being affected by interaction variations with said ferromagnetic or paramagnetic interface, said interaction being associated with spin polarization formed by temporary adsorption of the chiral molecules onto said at least one surface.

5. The system of claim 1, wherein said at least one ferromagnetic or paramagnetic substrate comprises ferromagnetic or paramagnetic layer providing an interface with said fluid mixture on an interface perpendicular to direction of magnetization thereof.

6. The system of claim 1, wherein said at least one ferromagnetic or paramagnetic substrate comprises one or more ferromagnetic or paramagnetic particles providing one or more corresponding interfaces with said fluid mixture.

7. The system of claim 6, wherein said one or more ferromagnetic or paramagnetic particles comprise a non-magnetic layer applied on one surface thereon thereby providing selected magnetic pole interfacing with said fluid mixture.

8. The system of claim 6, wherein said particles are attached in groups to two or more particles, said two or more particles of a group being attached at non-magnetic end thereof, thereby providing effectively magnetic monopole particles.

9. The system of claim 6, wherein said cavity comprises a matrix holding said particles in place within said cavity.

10. The system of claim 9, wherein said matrix is in the form of a grid positioned perpendicular to flow direction in the column.

11. The system of claim 10, wherein said particles on said grid are aligned with ferromagnetic or paramagnetic layer thereof directed against flow through the column.

12. The system of claim 1, wherein said one or more ferromagnetic or paramagnetic substrates are one or more paramagnetic substrates, the system furthers comprising a magnetic field generator applying magnetic field onto the cavity to thereby magnetize said one or more paramagnetic substrates.

13. (canceled)

14. The system of claim 1, further comprising an electrode arrangement comprising at least first and second electrodes located on at least first and second opposing sides of the column, said first and second electrodes apply electric field applied on said fluid mixture perpendicular to the flow direction, in the channel.

15. (canceled)

16. The system of claim 14, wherein said electrode arrangement is configured with said at least first and second electrodes located perpendicular to material flow through the column.

17. The system of claim 14, wherein said at least first and second electrodes are of different dimension at least in one dimension thereof, thereby providing electric gradient, said electric field gradient is larger at vicinity of said at least one ferromagnetic or paramagnetic substrate as compared to distant regions of the cavity.

18-26. (canceled)

27. A method for separating chiral molecules to corresponding enantiomers, the method comprising providing a fluid mixture comprising enantiomers of at least one type of chiral molecules, providing a substrate having magnetization in direction perpendicular to surface of the substrate being up or down with respect to the surface, flowing said mixture onto of said substrate for a given time period to allow molecules of the mixture to interact with said surface, thereby at least partially separating between enantiomers of said at least one type of chiral molecules.

28-29. (canceled)

30. The method of claim 27, further comprising applying electric field in direction perpendicular to said surface thereby increasing charge polarization of molecules in said fluid mixture.

31. The method of claim 27, comprising providing a plurality of substrates having magnetization in similar direction perpendicular to surface of the substrate being up or down with respect to the surface, and flowing said mixture onto said substrates one by one to thereby allow molecules of one type of enantiomer to interact on said substrate.

32. The method of claim 27, comprising flowing said fluid mixture in a channel having at least one region of interface with said substrate, thereby providing variation in flow rate for the different enantiomers of said at least one type of chiral molecules.

33. A system for separating chiral molecules, the system comprising a column configured for passing material flow, said column comprises at least one region comprising magnetic interface region interfacing with material flow through said column; said interface region being magnetized at direction perpendicular to said interface thereby introducing variation in adsorption energy between different enantiomers of chiral molecules and said interface.

34-50. (canceled)
